(19) United States
(12) Patent Application Publication
(10) Pub. No.: US 2023/0154211 A1
(43) Pub. Date: May 18, 2023

(54) IMAGE PROCESSING SYSTEM AND IMAGE PROCESSING METHOD

(71) Applicant: TOYOTA JIDOSHA KABUSHIKI KAISHA, Toyota-shi (JP)

(72) Inventors: Masahiro MORI, Nisshin-shi (JP); Takahiro FUJITA, Toyota-shi (JP)

(73) Assignee: TOYOTA JIDOSHA KABUSHIKI KAISHA, Toyota-shi (JP)

(21) Appl. No.: 17/954,494

(22) Filed: Sep. 28, 2022

(30) Foreign Application Priority Data
Nov. 18, 2021 (JP) 2021-187916

(51) Int. Cl. G06V 20/62; G06V 10/40

(52) U.S. Cl. CPC G06V 20/625; G06V 10/40; G06V 2201/08

(57) ABSTRACT

An image processing system includes a first camera configured to image vehicles including a target vehicle from a first angle at which a license plate of the target vehicle is imaged, a second camera configured to image the traveling vehicles from a second angle, and one or more processors configured to acquire first video data captured by the first camera and second video data captured by the second camera, select, as the target vehicle, a vehicle with a number that matches a number of the target vehicle from among the vehicles included in the first video data, identify the target vehicle from among the vehicles included in the second video data based on target vehicle information other than the number of the target vehicle. The target vehicle information is obtained from the target vehicle selected in the first video data.

### CROSS-REFERENCE TO RELATED APPLICATION

This application claims priority to Japanese Patent Application No. 2021-187916 filed on Nov. 18, 2021, incorporated herein by reference in its entirety.

### BACKGROUND

### 1. Technical Field

The present disclosure relates to an image processing system and an image processing method, and more specifically, to a technology for imaging a vehicle.

### 2. Description of Related Art

A user who likes driving may wish to image the appearance of his/her traveling vehicle. The user can post (upload) the captured image to, for example, a social networking service (hereinafter referred to as “SNS”) so that many people can view the image. However, it is difficult for the user to image the appearance of his/her traveling vehicle while driving the vehicle by himself/herself. In view of this, there has been proposed a service for imaging the appearance of a traveling vehicle.

For example, Japanese Unexamined Patent Application Publication No. 2019-121319 (JP 2019-121319 A) discloses a vehicle imaging assist device. When the license plate number of a vehicle is shown in an image captured by an imaging device, the vehicle imaging assist device determines that the vehicle is shown in the image, and posts the captured image to the SNS.

### SUMMARY

It is not always possible to image the license plate of a traveling vehicle. There may be demands for various images such as an image captured from an angle at which the license plate is not shown (for example, an image captured from the side of the vehicle) and an image showing the license plate in a small size (for example, an image captured at a location distant from the vehicle). The device disclosed in JP 2019-121319 A has room for improvement because such demands are not particularly taken into consideration.

The present disclosure identifies a vehicle even if the license plate number is not shown.

An image processing system according to a first aspect of the present disclosure includes a first camera configured to image vehicles including a target vehicle from a first angle at which a license plate of the target vehicle is imaged, a second camera configured to image the vehicles that are traveling from a second angle different from the first angle, and one or more processors configured to acquire first video data captured by the first camera and second video data captured by the second camera, select, as the target vehicle, a vehicle with a number that matches a number of the target vehicle from among the vehicles included in the first video data, identify the target vehicle from among the vehicles included in the second video data based on target vehicle information other than the number of the target vehicle, and generate an image including the target vehicle identified in the second video data. The target vehicle information is obtained from the target vehicle selected in the first video data.

In the aspect described above, the target vehicle information may include information on a traveling condition of the target vehicle, and the one or more processors may be configured to identify, as the target vehicle, a vehicle traveling under the traveling condition of the target vehicle from among the vehicles included in the second video data.

In the aspect described above, the target vehicle information may include information on an appearance of the target vehicle, and the one or more processors may be configured to identify, as the target vehicle, a vehicle of the same appearance as the appearance of the target vehicle from among the vehicles included in the second video data.

According to the configurations described above, the target vehicle information (information other than the number of the target vehicle; information on the traveling condition and the appearance of the target vehicle) is extracted by using the first video captured from the first angle at which the number of the license plate can be imaged. Based on the extracted target vehicle information, the vehicle in the second video captured from the second angle is identified. By linking the first video and the second video based on the target vehicle information, the vehicle can be identified even if the vehicle number is not shown in the second video.

In the aspect described above, the one or more processors may be configured to extract the vehicles from the first video data, recognize numbers of license plates of the extracted vehicles, associate each of the numbers of the license plates with a vehicle having a shortest distance from the license plate among the extracted vehicles, and select, as the target vehicle, a vehicle with a number that matches the number of the target vehicle.

According to the configuration described above, each of the vehicles is associated with the number having the shortest distance from the vehicle. Then, a vehicle having a number that matches the number of the target vehicle is selected as the target vehicle. As a result, the target vehicle in the first video data can be selected with high accuracy.

The image processing system may further include a first memory that stores a target vehicle identification model. The target vehicle identification model may be a trained model that receives an input of a video from which a vehicle is extracted, and outputs the vehicle in the video. The one or more processors may be configured to identify the target vehicle from the second video data based on the target vehicle identification model and the target vehicle information.

The image processing system may further include a second memory that stores a vehicle extraction model. The vehicle extraction model may be a trained model that receives an input of a video including a vehicle, and outputs the vehicle in the video. The one or more processors may be configured to extract the vehicles from the first video data using the vehicle extraction model.

The image processing system may further include a third memory that stores a number recognition model. The number recognition model may be a trained model that receives an input of a video including a number, and outputs the number in the video. The one or more processors may be configured to recognize the number of the license plate from the first video data using the number recognition model.

According to the configurations described above, the accuracies of the processes of the target vehicle identification, the vehicle extraction, and the number recognition can be improved by using the trained models prepared by machine learning.

An image processing method to be executed by a computer according to a second aspect of the present disclosure includes acquiring first video data in which vehicles including a target vehicle is imaged from a first angle at which a license plate of the target vehicle is imaged, acquiring second video data in which the vehicles that are traveling are imaged from a second angle different from the first angle, selecting, as the target vehicle, a vehicle with a number that matches a number of the target vehicle from among the vehicles included in the first video data, identifying the target vehicle from among the vehicles included in the second video data based on target vehicle information other than the number of the target vehicle, and generating an image including the target vehicle identified in the second video data. The target vehicle information is obtained from the target vehicle selected in the first video data.

According to the method described above, the vehicle can be identified even if the vehicle number is not shown in the second video similarly to the first aspect.

An image processing system according to a third aspect of the present disclosure includes one or more processors configured to acquire first video data in which one or more vehicles including a target vehicle are imaged from a first angle at which a license plate of the target vehicle is imaged, and second video data in which the one or more vehicles that are traveling are imaged from a second angle different from the first angle, select, as the target vehicle, a vehicle with a number that matches a number of the target vehicle from among the one or more vehicles included in the first video data, identify the target vehicle from among the one or more vehicles included in the second video data based on target vehicle information other than the number of the target vehicle, and generate an image including the target vehicle identified in the second video data. The target vehicle information is obtained from the target vehicle selected in the first video data.

According to the present disclosure, the vehicle can be identified even if the license plate number is not shown.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an overall configuration of an image processing system according to an embodiment;

FIG. 2 is a block diagram showing a typical hardware configuration of an imaging system;

FIG. 3 is a first diagram (perspective view) showing how the imaging system images a vehicle;

FIG. 4 is a second diagram (top view) showing how the imaging system images the vehicle;

FIG. 5 is a diagram showing an example of one frame of an identification video;

FIG. 6 is a diagram showing an example of one frame of a viewing video;

FIG. 7 is a block diagram showing a typical hardware configuration of a server 2;

FIG. 8 is a functional block diagram showing functional configurations of the imaging system and the server;

FIG. 9 is a diagram for describing an example of a trained model (vehicle extraction model) to be used in a vehicle extraction process;

FIG. 10 is a diagram for describing an example of a trained model (number recognition model) to be used in a number recognition process;

FIG. 11 is a diagram for describing an example of a trained model (target vehicle identification model) to be used in a target vehicle identification process; and

FIG. 12 is a flowchart showing a processing procedure of a vehicle imaging process according to the embodiment.

### DETAILED DESCRIPTION OF EMBODIMENTS

Hereinafter, an embodiment of the present disclosure will be described in detail with reference to the drawings. In the drawings, the same or corresponding portions are denoted by the same reference signs and the description thereof will not be repeated.

### Embodiment

System Configuration

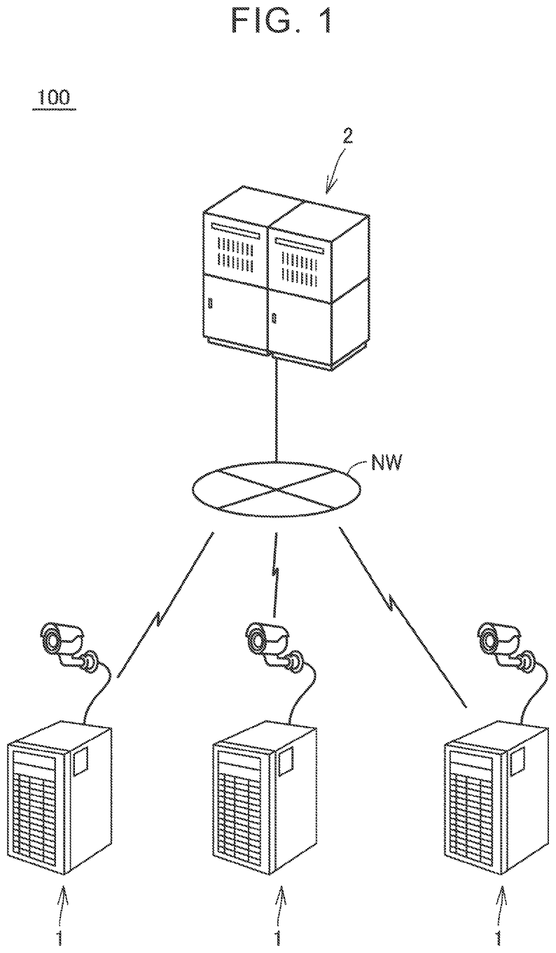

FIG. 1 is a diagram schematically showing an overall configuration of an image processing system according to the present embodiment. An image processing system 100 includes a plurality of imaging systems 1 and a server 2. The imaging systems 1 and the server 2 are communicably connected to each other via a network NW. Although three imaging systems 1 are shown in FIG. 1, the number of imaging systems 1 is not particularly limited. Only one imaging system 1 may be provided.

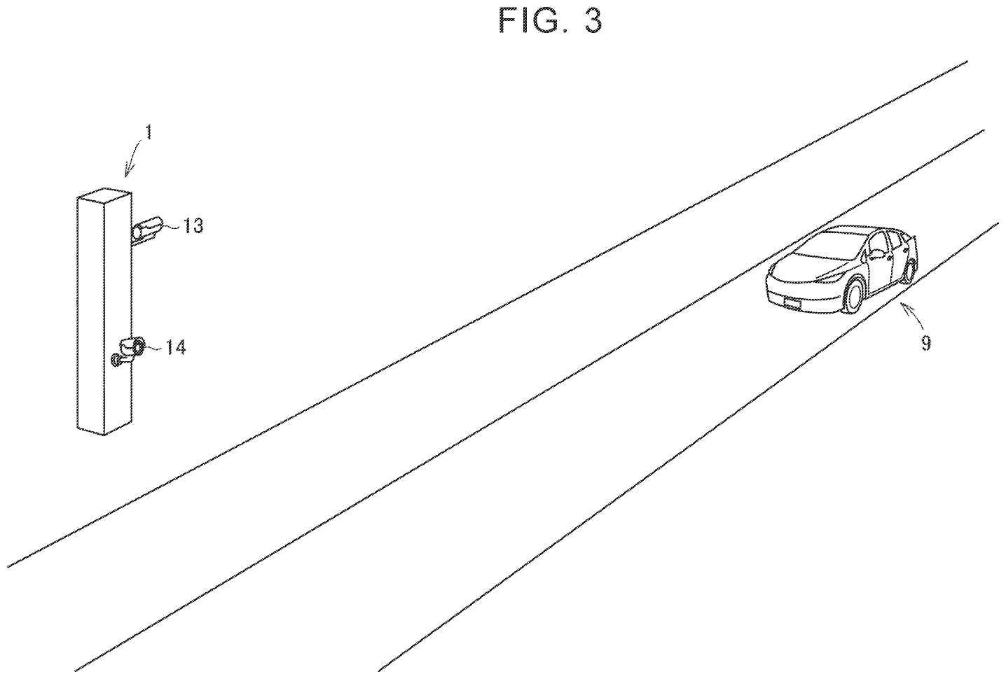

The imaging system 1 is installed, for example, near a road and images a vehicle 9 (see FIG. 3) traveling on the road. In the present embodiment, the imaging system 1 performs a predetermined arithmetic process (described later) on a captured video, and transmits a result of the arithmetic process to the server 2 together with the video.

The server 2 is, for example, an in-house server of a business operator that provides a vehicle imaging service. The server 2 may be a cloud server provided by a cloud server management company. The server 2 generates an image to be viewed by a user (hereinafter referred to also as “viewing image”) from a video received from the imaging system 1, and provides the generated viewing image to the user. The viewing image is generally a still image, but may be a short video. In many cases, the user is a driver of the vehicle 9, but is not particularly limited.

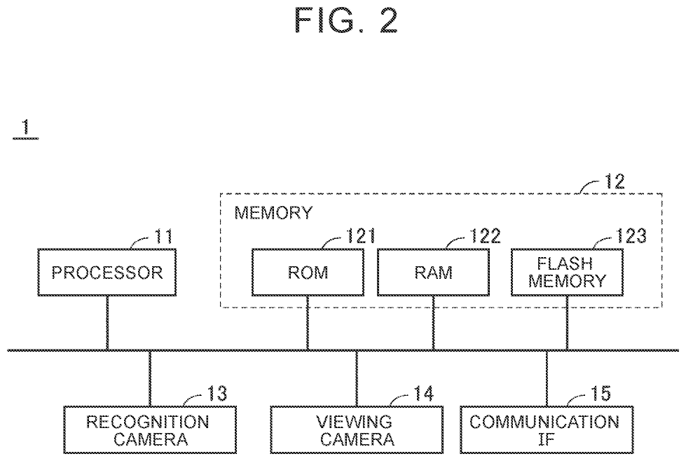

FIG. 2 is a block diagram showing a typical hardware configuration of the imaging system 1. The imaging system 1 includes a processor 11, a memory 12, a recognition camera 13, a viewing camera 14, and a communication interface (IF) 15. The memory 12 includes a read only memory (ROM) 121, a random access memory (RAM) 122, and a flash memory 123. The components of the imaging system 1 are connected to each other by a bus or the like.

The processor 11 controls the overall operation of the imaging system 1. The memory 12 stores programs (operating system and application programs) to be executed by the processor 11, and data (maps, tables, mathematical expressions, parameters, etc.) to be used in the programs. The memory 12 temporarily stores a video captured by the imaging system 1.

The recognition camera 13 captures a video to be used by the processor 11 to recognize a license plate number of the vehicle 9 (hereinafter referred to also as “identification video”). The viewing camera 14 captures a video to be used for generating a viewing image (hereinafter referred to also as “viewing video”). Each of the recognition camera 13 and the viewing camera 14 may be a high-sensitivity camera with a polarizing lens.

The recognition camera 13 corresponds to a “first camera” according to the present disclosure. The identification video corresponds to “first video data”. The viewing camera 14 corresponds to a “second camera” according to the present disclosure. The viewing video corresponds to “second video data”.

The communication IF 15 is an interface for communicating with the server 2. The communication IF 15 is, for example, a communication module compliant with 4th generation (4G) or 5G.

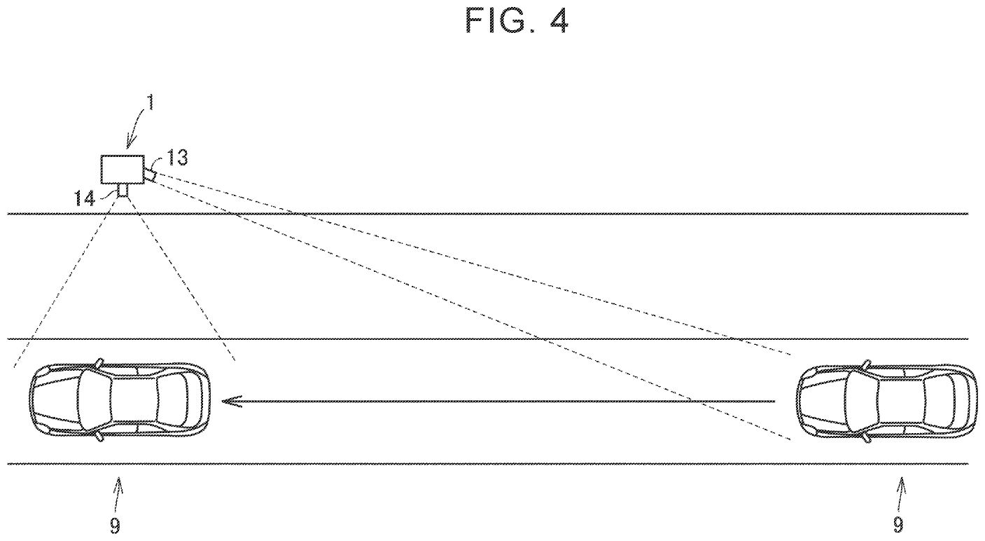

FIG. 3 is a first diagram (perspective view) showing how the imaging system 1 images a vehicle. FIG. 4 is a second diagram (top view) showing how the imaging system 1 images the vehicle. Referring to FIGS. 3 and 4, the recognition camera 13 captures an identification video from an angle (first angle) at which a license plate can be imaged. In this example, the identification video is captured substantially in front of the vehicle 9. The viewing camera 14 captures a viewing video from an angle (second angle) at which the subject is photogenic (especially on an SNS). In this example, the viewing video is captured at the side of the vehicle 9.

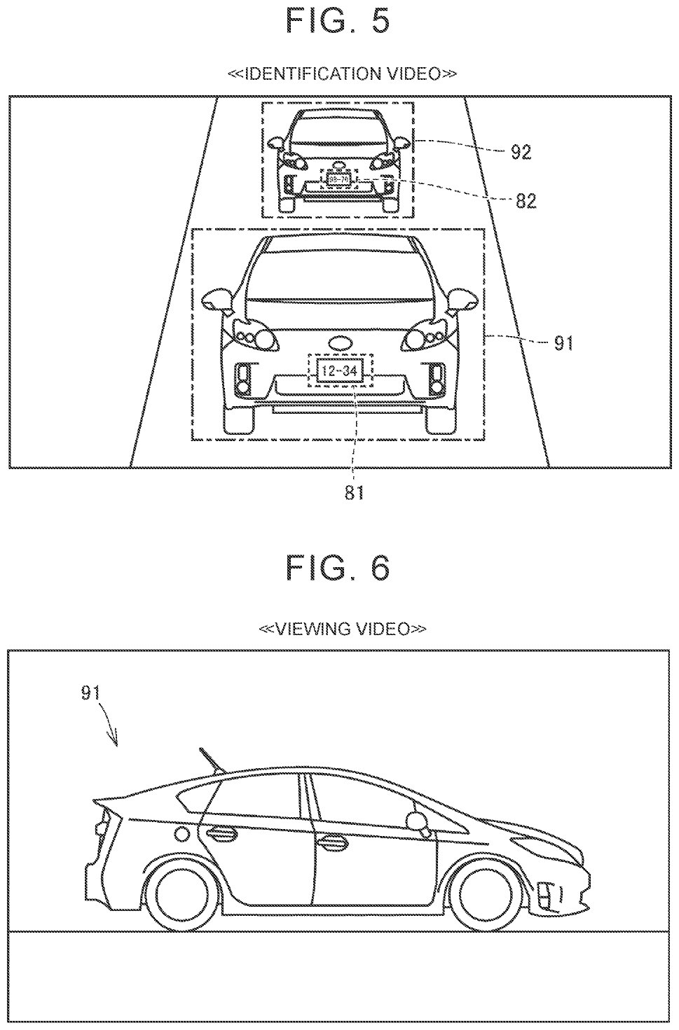

FIG. 5 is a diagram showing an example of one frame of the identification video. As shown in FIG. 5, a plurality of vehicles 9 (91, 92) may be shown in the identification video. Among the vehicles, a vehicle to be imaged (vehicle that is a subject of a viewing image) is hereinafter referred to as “target vehicle”, and is distinguished from other vehicles.

FIG. 6 is a diagram showing an example of one frame of the viewing video. It is not necessary that the license plate of the target vehicle be shown in the viewing video. The license plate of the target vehicle may be shown in the viewing video.

The vehicles 9 (including the target vehicle) are not limited to four-wheel vehicles shown in FIGS. 3 to 5, and may be, for example, two-wheel vehicles (motorcycles). Since the license plate of the two-wheel vehicle is attached only to the rear, it is likely that the license plate cannot be imaged.

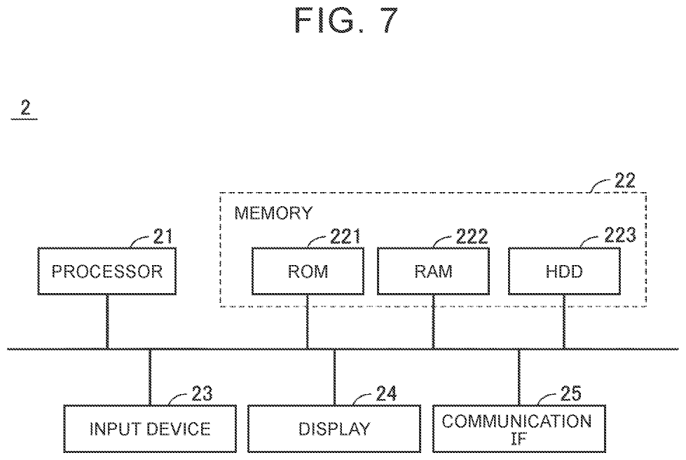

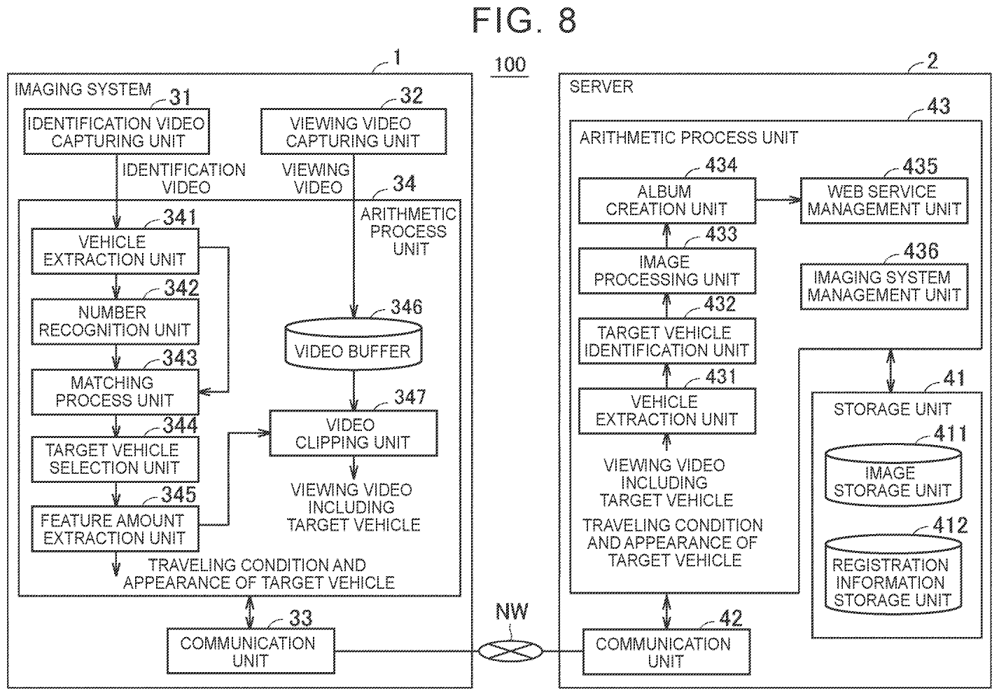

FIG. 7 is a block diagram showing a typical hardware configuration of the server 2. The server 2 includes a processor 21, a memory 22, an input device 23, a display 24, and a communication IF 25. The memory 22 includes a ROM 221, a RAM 222, and a hard disk drive (HDD) 223. The components of the server 2 are connected to each other by a bus or the like.

The processor 21 executes various arithmetic processes in the server 2. The memory 22 stores programs to be executed by the processor 21, and data to be used in the programs. The memory 22 stores data to be used for image processing by the server 2, and data subjected to the image processing by the server 2. The input device 23 receives an input from an administrator of the server 2. The input device 23 is typically a keyboard and a mouse. The display 24 displays various types of information. The communication IF 25 is an interface for communicating with the imaging system 1.

### Functional Configuration of Image Processing System

FIG. 8 is a functional block diagram showing functional configurations of the imaging system 1 and the server 2. The imaging system 1 includes an identification video capturing unit 31, a viewing video capturing unit 32, a communication unit 33, and an arithmetic process unit 34. The arithmetic process unit 34 includes a vehicle extraction unit 341, a number recognition unit 342, a matching process unit 343, a target vehicle selection unit 344, a feature amount extraction unit 345, a video buffer 346, and a video clipping unit 347.

The identification video capturing unit 31 captures an identification video to be used by the number recognition unit 342 to recognize a license plate number. The identification video capturing unit 31 outputs the identification video to the vehicle extraction unit 341. The identification video capturing unit 31 corresponds to the recognition camera 13 in FIG. 2.

The viewing video capturing unit 32 captures a viewing video to be viewed by the user of the vehicle 9. The viewing video capturing unit 32 outputs the viewing video to the video buffer 346. The viewing video capturing unit 32 corresponds to the viewing camera 14 in FIG. 2.

The communication unit 33 performs bidirectional communication with a communication unit 42 (described later) of the server 2 via the network NW. The communication unit 33 receives the number of the target vehicle from the server 2. The communication unit 33 transmits a viewing video (more specifically, a video clipped from the viewing video to include the target vehicle) to the server 2. The communication unit 33 corresponds to the communication IF 15 in FIG. 2.

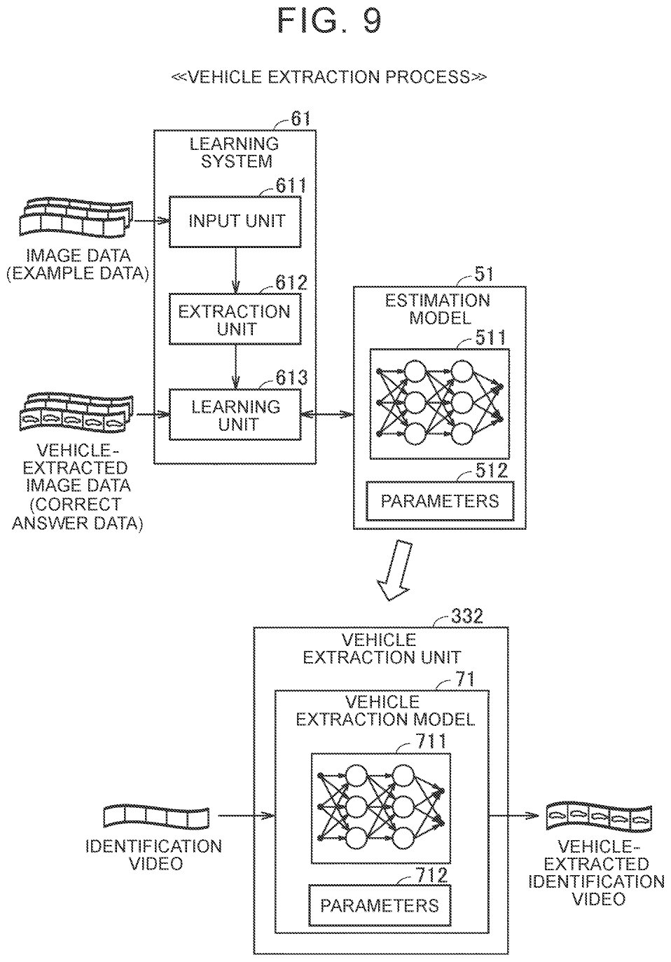

The vehicle extraction unit 341 extracts a vehicle (not only the target vehicle but vehicles as a whole) from an identification video. This process is referred to also as “vehicle extraction process”. For example, a trained model generated by a machine learning technology such as deep learning can be used for the vehicle extraction process. In this example, the vehicle extraction unit 341 is implemented by a “vehicle extraction model”. The vehicle extraction model will be described with reference to FIG. 9. The vehicle extraction unit 341 outputs a video from which a vehicle is extracted (frame including a vehicle) in the identification video to the number recognition unit 342 and the matching process unit 343.

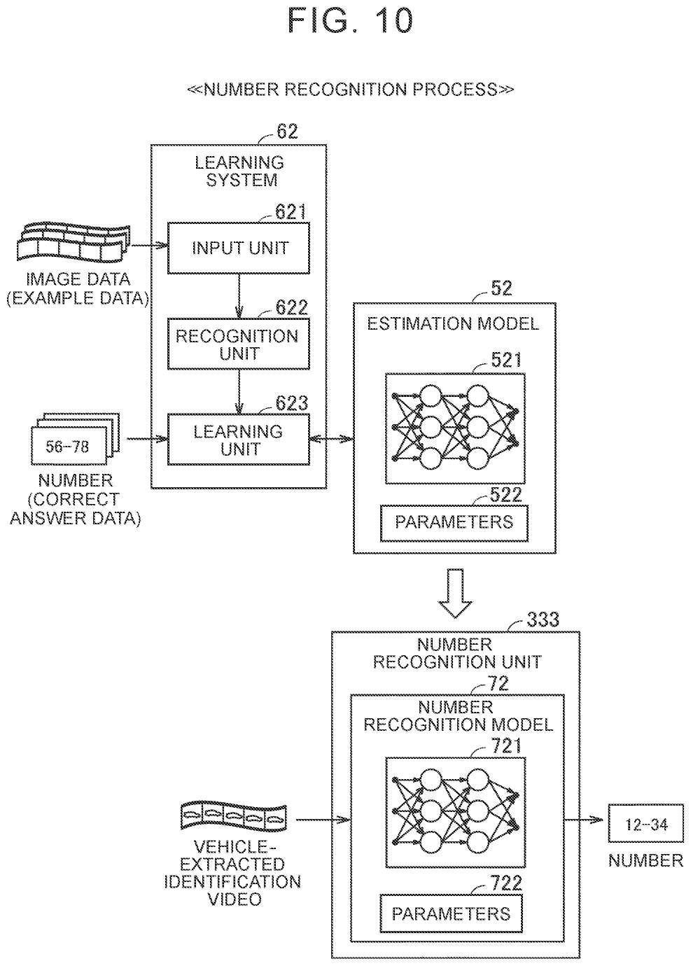

The number recognition unit 342 recognizes a license plate number in the video from which the vehicle is extracted by the vehicle extraction unit 341. This process is referred to also as “number recognition process”. A trained model generated by a machine learning technology such as deep learning can be used also for the number recognition process. In this example, the number recognition unit 342 is implemented by a “number recognition model”. The number recognition model will be described with reference to FIG. 10. The number recognition unit 342 outputs the recognized number to the matching process unit 343. The number recognition unit 342 outputs the recognized number also to the communication unit 33. As a result, the number of each vehicle is transmitted to the server 2.

The matching process unit 343 associates the vehicle extracted by the vehicle extraction unit 341 with the number recognized by the number recognition unit 342. This process is referred to also as “matching process”. Specifically, referring to FIG. 5 again, description will be given of an exemplary situation in which two vehicles 91 and 92 are extracted and two numbers 81 and 82 are recognized. The matching process unit 343 calculates, for each number, a distance between the number and each vehicle (distance between coordinates of the number and coordinates of each vehicle on the frame). Then, the matching process unit 343 matches the number with a vehicle having a shorter distance from the number. In this example, the matching process unit 343 associates the number 81 with the vehicle 91 because the distance between the number 81 and the vehicle 91 is shorter than the distance between the number 81 and the vehicle 92. Similarly, the matching process unit 343 associates the number 82 with the vehicle 92. The matching process unit 343 outputs results of the matching process (vehicles associated with the numbers) to the target vehicle selection unit 344.

The target vehicle selection unit 344 selects, as the target vehicle, a vehicle whose number matches the number of the target vehicle (received from the server 2) from among the vehicles associated with the numbers by the matching process. The target vehicle selection unit 344 outputs the vehicle selected as the target vehicle to the feature amount extraction unit 345.

The feature amount extraction unit 345 extracts a feature amount of the target vehicle by analyzing the video including the target vehicle. More specifically, the feature amount extraction unit 345 calculates a traveling speed of the target vehicle based on a temporal change of the target vehicle in the frames including the target vehicle (for example, an amount of movement of the target vehicle between the frames or an amount of change in the size of the target vehicle between the frames). The feature amount extraction unit 345 may calculate, for example, an acceleration (deceleration) of the target vehicle in addition to the traveling speed of the target vehicle. The feature amount extraction unit 345 extracts information on the appearance (body shape, body color, etc.) of the target vehicle by using a known image recognition technology. The feature amount extraction unit 345 outputs the feature amount (traveling condition and appearance) of the target vehicle to the video clipping unit. The feature amount extraction unit 345 outputs the feature amount of the target vehicle also to the communication unit 33. As a result, the feature amount of the target vehicle is transmitted to the server 2.

The video buffer 346 temporarily stores the viewing video. The video buffer 346 is typically a ring buffer (circular buffer), and has an annular storage area in which the beginning and the end of a one-dimensional array are logically connected to each other. A newly captured viewing video is stored in the video buffer 346 in an amount corresponding to a predetermined period that can be stored in the storage area. The viewing video that exceeds the predetermined period (old video) is automatically deleted from the video buffer 346.

The video clipping unit 347 clips, from the viewing video stored in the video buffer 346, a part having a strong possibility that the target vehicle is imaged based on the feature amount (traveling speed, acceleration, body shape, body color, etc. of the target vehicle) extracted by the feature amount extraction unit 345. More specifically, a distance between an imaging location of the identification video capturing unit 31 (recognition camera 13) and an imaging location of the viewing video capturing unit 32 (viewing camera 14) is known. Therefore, if the traveling speed (and the acceleration) of the target vehicle is known, the video clipping unit 347 can calculate a time difference between a timing when the target vehicle is imaged by the identification video capturing unit 31 and a timing when the target vehicle is imaged by the viewing video capturing unit 32. The video clipping unit 347 calculates the timing when the target vehicle is imaged by the viewing video capturing unit 32 based on the timing when the target vehicle is imaged by the identification video capturing unit 31 and the time difference. Then, the video clipping unit 347 clips, from the viewing video stored in the video buffer 346, a video having a predetermined duration (for example, several seconds to several tens of seconds) including the timing when the target vehicle is imaged. The video clipping unit 347 outputs the clipped viewing video to the communication unit 33. As a result, the viewing video including the target vehicle is transmitted to the server 2.

The video clipping unit 347 may clip the viewing video at a predetermined timing regardless of the feature amount extracted by the feature amount extraction unit 345. That is, the video clipping unit 347 may clip the viewing video captured by the viewing video capturing unit 32 after a predetermined time difference from the timing when the target vehicle is imaged by the identification video capturing unit 31.

The server 2 includes a storage unit 41, the communication unit 42, and an arithmetic process unit 43. The storage unit 41 includes an image storage unit 411 and a registration information storage unit 412. The arithmetic process unit 43 includes a vehicle extraction unit 431, a target vehicle identification unit 432, an image processing unit 433, an album creation unit 434, a web service management unit 435, and an imaging system management unit 436.

The image storage unit 411 stores a viewing image obtained as a result of an arithmetic process by the server 2. More specifically, the image storage unit 411 stores images before and after processing by the image processing unit 433, and an album created by the album creation unit 434.

The registration information storage unit 412 stores registration information related to the vehicle imaging service. The registration information includes personal information of a user who applied for the provision of the vehicle imaging service, and vehicle information of the user. The personal information of the user includes, for example, information on an identification number (ID), a name, a date of birth, an address, a telephone number, and an e-mail address of the user. The vehicle information of the user includes information on a license plate number of the vehicle. The vehicle information may include, for example, information on a vehicle model, a model year, a body shape (sedan, wagon, or van), and a body color.

The communication unit 42 performs bidirectional communication with the communication unit 33 of the imaging system 1 via the network NW. The communication unit 42 transmits the number of the target vehicle to the imaging system 1. The communication unit 42 receives a viewing video including the target vehicle and a feature amount (traveling condition and appearance) of the target vehicle from the imaging system 1. The communication unit 42 corresponds to the communication IF 25 in FIG. 7.

The vehicle extraction unit 431 extracts a vehicle (not only the target vehicle but vehicles as a whole) from the viewing video. In this process, a vehicle extraction model can be used similarly to the vehicle extraction process by the vehicle extraction unit 341 of the imaging system 1. The vehicle extraction unit 431 outputs a video from which a vehicle is extracted in the viewing video (frame including a vehicle) to the target vehicle identification unit 432.

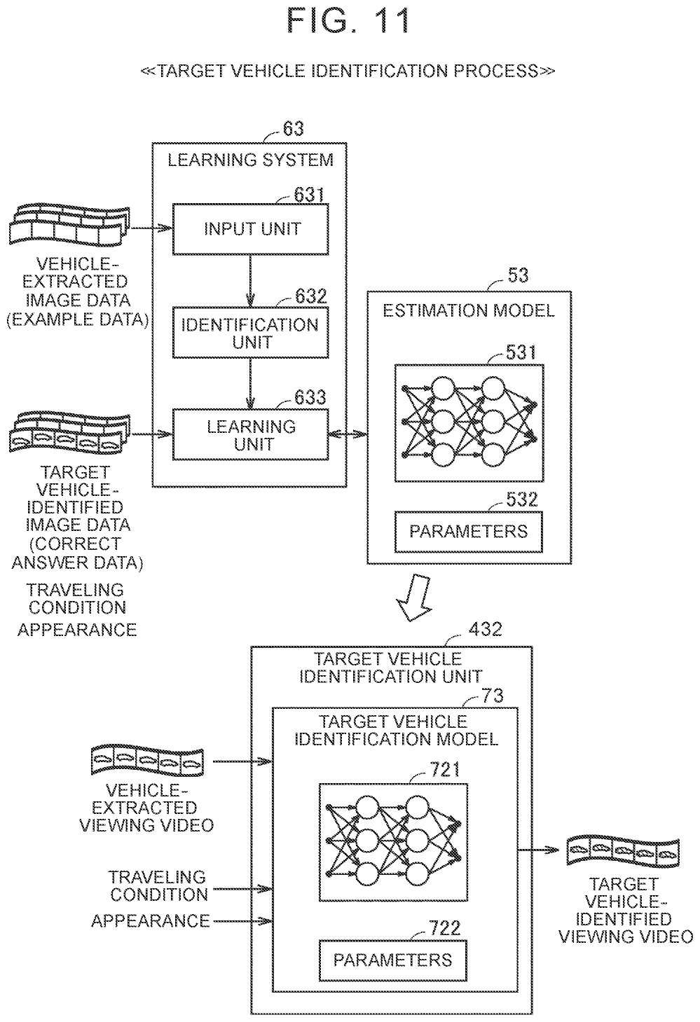

The target vehicle identification unit 432 identifies the target vehicle from among the vehicles extracted by the vehicle extraction unit 431 based on the feature amount of the target vehicle (that is, the traveling condition such as a traveling speed and an acceleration, and the appearance such as a body shape and a body color). This process is referred to also as “target vehicle identification process”. A trained model generated by a machine learning technology such as deep learning can be used also for the target vehicle identification process. In this example, the target vehicle identification unit 432 is implemented by a “target vehicle identification model”. The target vehicle identification will be described with reference to FIG. 11. A viewing image is generated by identifying the target vehicle by the target vehicle identification unit 432. The viewing image normally includes a plurality of images (a plurality of frames continuous in time). The target vehicle identification unit 432 outputs the viewing image to the image processing unit 433.

The image processing unit 433 processes the viewing image. For example, the image processing unit 433 selects a most photogenic image (so-called best shot) from among the plurality of images. Then, the image processing unit 433 performs various types of image correction (trimming, color correction, distortion correction, etc.) on the extracted viewing image. The image processing unit 433 outputs the processed viewing image to the album creation unit 434.

The album creation unit 434 creates an album by using the processed viewing image. A known image analysis technology (for example, a technology for automatically creating a photo book, a slide show, or the like from images captured by a smartphone) can be used for creating the album. The album creation unit 434 outputs the album to the web service management unit 435.

The web service management unit 435 provides a web service (for example, an application program that can be linked to an SNS) using the album created by the album creation unit 434. The web service management unit 435 may be implemented on a server different from the server 2.

The imaging system management unit 436 manages (monitors and diagnoses) the imaging system 1. In the event of some abnormality (camera failure, communication failure, etc.) in the imaging system 1 under management, the imaging system management unit 436 notifies the administrator of the server 2 about the abnormality. As a result, the administrator can take measures such as inspection or repair of the imaging system 1. The imaging system management unit 436 may be implemented as a separate server similarly to the web service management unit 435.

Trained Models

FIG. 9 is a diagram for describing an example of the trained model (vehicle extraction model) to be used in the vehicle extraction process. An estimation model 51 that is a pre-learning model includes, for example, a neural network 511 and parameters 512. The neural network 511 is a known neural network to be used for an image recognition process by deep learning. Examples of the neural network include a convolution neural network (CNN) and a recurrent neural network (RNN). The parameters 512 include a weighting coefficient and the like to be used in arithmetic operations by the neural network 511.

A large amount of teaching data is prepared in advance by a developer. The teaching data includes example data and correct answer data. The example data is image data including a vehicle to be extracted. The correct answer data includes an extraction result associated with the example data. Specifically, the correct answer data is image data including the vehicle extracted from the example data.

A learning system 61 trains the estimation model 51 by using the example data and the correct answer data. The learning system 61 includes an input unit 611, an extraction unit 612, and a learning unit 613.

The input unit 611 receives a large amount of example data (image data) prepared by the developer, and outputs the data to the extraction unit 612.

By inputting the example data from the input unit 611 into the estimation model 51, the extraction unit 612 extracts a vehicle included in the example data for each piece of example data. The extraction unit 612 outputs the extraction result (output from the estimation model 51) to the learning unit 613.

The learning unit 613 trains the estimation model 51 based on the vehicle extraction result from the example data that is received from the extraction unit 612 and the correct answer data associated with the example data. Specifically, the learning unit 613 adjusts the parameters 512 (for example, the weighting coefficient) so that the vehicle extraction result obtained by the extraction unit 612 approaches the correct answer data.

The estimation model 51 is trained as described above, and the trained estimation model 51 is stored in the vehicle extraction unit 341 (and the vehicle extraction unit 431) as a vehicle extraction model 71. The vehicle extraction model 71 receives an input of an identification video, and outputs an identification video from which a vehicle is extracted. The vehicle extraction model 71 outputs, for each frame of the identification video, the extracted vehicle in association with an identifier of the frame to the matching process unit 343. The frame identifier is, for example, a time stamp (time information of the frame).

FIG. 10 is a diagram for describing an example of the trained model (number recognition model) to be used in the number recognition process. Example data is image data including a number to be recognized. Correct answer data is data indicating a position and a number of a license plate included in the example data. Although the example data and the correct answer data are different, the learning method for an estimation model 52 by a learning system 62 is the same as the learning method by the learning system 61 (see FIG. 9). Therefore, detailed description is not repeated.

The trained estimation model 52 is stored in the number recognition unit 342 as a number recognition model 72. The number recognition model 72 receives an input of an identification video from which a vehicle is extracted by the vehicle extraction unit 341, and outputs coordinates and a number of a license plate. The number recognition model 72 outputs, for each frame of the identification video, the recognized coordinates and number of the license plate in association with an identifier of the frame to the matching process unit 343.

FIG. 11 is a diagram for describing an example of the trained model (target vehicle identification model) to be used in the target vehicle identification process. Example data is image data including a target vehicle to be identified. The example data further includes information on a feature amount (specifically, a traveling condition and appearance) of the target vehicle. Correct answer data is image data including the target vehicle identified in the example data. The learning method for an estimation model 53 by a learning system 63 is the same as the learning methods by the learning systems 61 and 62 (see FIGS. 9 and 10). Therefore, detailed description is not repeated.

The trained estimation model 53 is stored in the target vehicle identification unit 432 as a target vehicle identification model 73. The target vehicle identification model 73 receives an input of a viewing video from which a vehicle is extracted by the vehicle extraction unit 431 and a feature amount (traveling condition and appearance) of the target vehicle, and outputs a viewing video including the identified target vehicle. The target vehicle identification model 73 outputs, for each frame of the viewing video, the identified viewing video in association with an identifier of the frame to the image processing unit 433.

The vehicle extraction process is not limited to the process using the machine learning. A known image recognition technology (image recognition model or algorithm) that does not use the machine learning can be applied to the vehicle extraction process. The same applies to the number recognition process and the target vehicle identification process.

Processing Flow

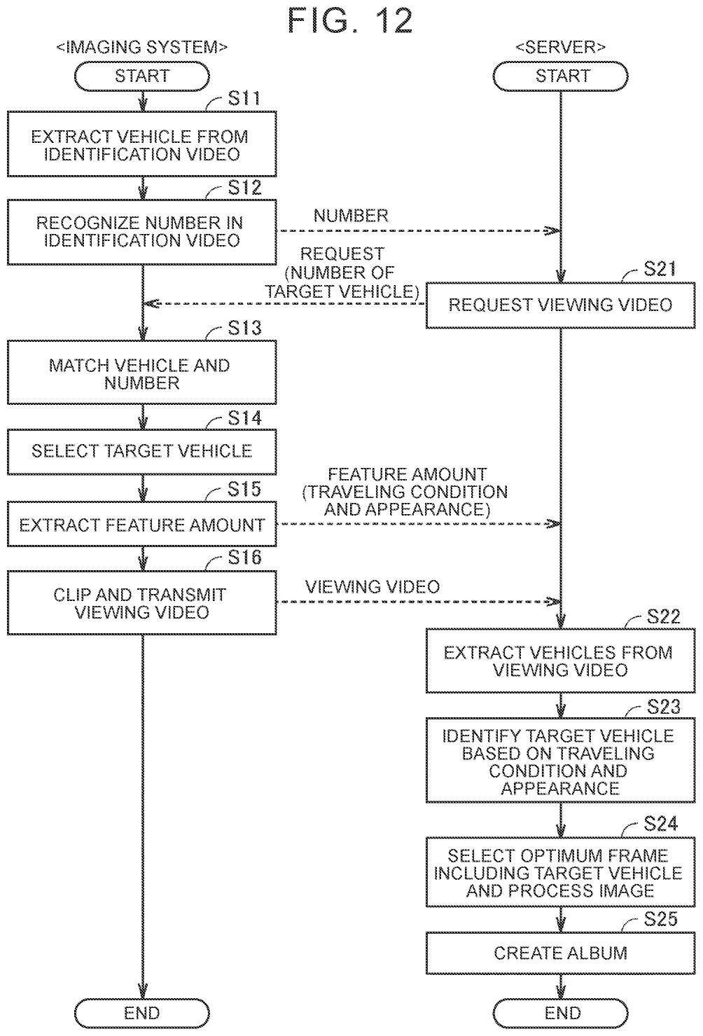

FIG. 12 is a flowchart showing a processing procedure of the vehicle imaging process according to the present embodiment. This flowchart is executed, for example, when a predetermined condition is satisfied or at a predetermined cycle. In FIG. 12, the process performed by the imaging system 1 is shown on the left side, and the process performed by the server 2 is shown on the right side. Each step is realized by software processing by the processor 11 or the processor 21, but may be realized by hardware (electric circuit). Hereinafter, the step is abbreviated as “S”.

In S11, the imaging system 1 extracts a vehicle by executing the vehicle extraction process (see FIG. 9) for an identification video. The imaging system 1 recognizes a number by executing the number recognition process (see FIG. 10) for the identification video from which the vehicle is extracted (S12). The imaging system 1 transmits the recognized number to the server 2.

When the number is received from the imaging system 1, the server 2 refers to registration information to determine whether the received number is a registered number (that is, the vehicle imaged by the imaging system 1 is a vehicle of a user who applied for the provision of the vehicle imaging service (target vehicle)). When the received number is the registered number (the number of the target vehicle), the server 2 transmits the number of the target vehicle and requests the imaging system 1 to transmit a viewing video including the target vehicle (S21).

In S13, the imaging system 1 executes the matching process between each vehicle and each number in the identification video. Then, the imaging system 1 selects, as the target vehicle, a vehicle associated with the same number as the number of the target vehicle from among the vehicles associated with the numbers (S14). The imaging system 1 extracts a feature amount (traveling condition and appearance) of the target vehicle, and transmits the extracted feature amount to the server 2 (S15).

In S16, the imaging system 1 clips a part including the target vehicle from the viewing video temporarily stored in the memory 22 (video buffer 346). In this clipping, the traveling condition (traveling speed, acceleration, etc.) and the appearance (body shape, body color, etc.) of the target vehicle can be used as described above. The imaging system 1 transmits the clipped viewing video to the server 2.

In S22, the server 2 extracts vehicles by executing the vehicle extraction process (see FIG. 9) for the viewing video received from the imaging system 1.

In S23, the server 2 identifies the target vehicle from among the vehicles extracted in S22 based on the feature amount (traveling condition and appearance) of the target vehicle (target vehicle identification process in FIG. 11). It is also conceivable to use only one of the traveling condition and the appearance of the target vehicle as the feature amount of the target vehicle. However, the viewing video may include a plurality of vehicles having the same body shape and body color, or may include a plurality of vehicles having substantially the same traveling speed and acceleration. In the present embodiment, the target vehicle can be distinguished from the other vehicles when the traveling speed and/or the acceleration are/is different among the vehicles even if the viewing video includes the vehicles having the same body shape and body color. Alternatively, the target vehicle can be distinguished from the other vehicles when the body shape and/or the body color are/is different among the vehicles even if the viewing video includes the vehicles having substantially the same traveling speed and acceleration. By using both the traveling condition and the appearance of the target vehicle as the feature amount of the target vehicle, the accuracy of the target vehicle identification can be improved.

It is not essential to use both the traveling condition and the appearance of the target vehicle, and only one of them may be used. The information on the traveling condition and/or the appearance of the target vehicle corresponds to “target vehicle information” according to the present disclosure. The information on the appearance of the target vehicle is not limited to the vehicle information obtained by the analysis performed by the imaging system 1 (feature amount extraction unit 345), but may be vehicle information prestored in the registration information storage unit 412.

In S24, the server 2 selects an optimum viewing image (best shot) from the viewing video (plurality of viewing images) including the target vehicle. The server 2 performs image correction on the optimum viewing image. Then, the server 2 creates an album by using the corrected viewing image (S25). The user can view the created album and post a desired image in the album to the SNS.

As described above, in the present embodiment, the feature amount (traveling information and appearance) of the target vehicle is extracted by using the identification video captured from the angle at which the license plate number can be imaged. Based on the extracted feature amount, the target vehicle in the viewing video captured from another angle is identified. By linking the identification video and the viewing video based on the feature amount of the target vehicle, the target vehicle can be identified even if the number of the target vehicle is not shown in the viewing video.

In the present embodiment, description has been given of the example in which the imaging system 1 and the server 2 share the execution of the image processing. Therefore, both the processor 11 of the imaging system 1 and the processor 21 of the server 2 correspond to a “processor” according to the present disclosure. The imaging system 1 may execute all the image processing and transmit the image-processed data (viewing image) to the server 2. Therefore, the server 2 is not an essential component for the image processing according to the present disclosure. In this case, the processor 11 of the imaging system 1 corresponds to the “processor” according to the present disclosure. Conversely, the imaging system 1 may transmit all the captured videos to the server 2, and the server 2 may execute all the image processing. In this case, the processor 21 of the server 2 corresponds to the “processor” according to the present disclosure. In the present embodiment, description has been given of the example in which the recognition camera 13 and the viewing camera 14 share the execution of the video capturing, but the use of two cameras is not an essential feature. One camera may capture the identification video and the viewing video. In the present embodiment, description has been given of the case where the recognition camera 13 images a plurality of vehicles, but the recognition camera 13 may image at least the target vehicle.

The embodiment disclosed herein should be considered to be illustrative and not restrictive in all respects. The scope of the present disclosure is shown by the claims rather than by the above description of the embodiment, and is intended to include all modifications within the meaning and scope equivalent to the claims.

What is claimed is:

1. An image processing system comprising:
a first camera configured to image vehicles including a target vehicle from a first angle at which a license plate of the target vehicle is imaged;
a second camera configured to image the vehicles that are traveling from a second angle different from the first angle; and
one or more processors configured to
acquire first video data captured by the first camera and second video data captured by the second camera,
select, as the target vehicle, a vehicle with a number that matches a number of the target vehicle from among the vehicles included in the first video data,
identify the target vehicle from among the vehicles included in the second video data based on target vehicle information other than the number of the target vehicle, the target vehicle information being obtained from the target vehicle selected in the first video data, and
generate an image including the target vehicle identified in the second video data.

2. The image processing system according to claim 1, wherein:
the target vehicle information includes information on a traveling condition of the target vehicle; and
the one or more processors are configured to identify, as the target vehicle, a vehicle traveling under the traveling condition of the target vehicle from among the vehicles included in the second video data.

3. The image processing system according to claim 1, wherein:
the target vehicle information includes information on an appearance of the target vehicle; and
the one or more processors are configured to identify, as the target vehicle, a vehicle of a same appearance as the appearance of the target vehicle from among the vehicles included in the second video data.

4. The image processing system according to claim 1, wherein the one or more processors are configured to:
extract the vehicles from the first video data;
recognize numbers of license plates of the extracted vehicles;
associate each of the numbers of the license plates with a vehicle having a shortest distance from the license plate among the extracted vehicles; and
select, as the target vehicle, a vehicle with a number that matches the number of the target vehicle.

5. The image processing system according to claim 1, further comprising a first memory that stores a target vehicle identification model, wherein:
the target vehicle identification model is a trained model that receives an input of a video from which a vehicle is extracted, and outputs the vehicle in the video; and
the one or more processors are configured to identify the target vehicle from the second video data based on the target vehicle identification model and the target vehicle information.

6. The image processing system according to claim 4, further comprising a second memory that stores a vehicle extraction model, wherein:
the vehicle extraction model is a trained model that receives an input of a video including a vehicle, and outputs the vehicle in the video; and
the one or more processors are configured to extract the vehicles from the first video data using the vehicle extraction model.

7. The image processing system according to claim 1, further comprising a third memory that stores a number recognition model, wherein:
the number recognition model is a trained model that receives an input of a video including a number, and outputs the number in the video; and
the one or more processors are configured to recognize the number of the license plate from the first video data using the number recognition model.

8. An image processing method to be executed by a computer, comprising:
acquiring first video data in which vehicles including a target vehicle is imaged from a first angle at which a license plate of the target vehicle is imaged;
acquiring second video data in which the vehicles that are traveling are imaged from a second angle different from the first angle;
selecting, as the target vehicle, a vehicle with a number that matches a number of the target vehicle from among the vehicles included in the first video data;
identifying the target vehicle from among the vehicles included in the second video data based on target vehicle information other than the number of the target vehicle, the target vehicle information being obtained from the target vehicle selected in the first video data; and
generating an image including the target vehicle identified in the second video data.

9. An image processing system comprising one or more processors configured to:
acquire first video data in which one or more vehicles including a target vehicle are imaged from a first angle at which a license plate of the target vehicle is imaged, and second video data in which the one or more vehicles that are traveling are imaged from a second angle different from the first angle;
select, as the target vehicle, a vehicle with a number that matches a number of the target vehicle from among the one or more vehicles included in the first video data;
identify the target vehicle from among the one or more vehicles included in the second video data based on target vehicle information other than the number of the target vehicle, the target vehicle information being obtained from the target vehicle selected in the first video data; and
generate an image including the target vehicle identified in the second video data.
